(19) United States
(12) Patent Application Publication
(10) Pub. No.: US 2019/0213768 A1
(43) Pub. Date: Jul. 11, 2019

(54) MEDIA CONTENT EDITING PLATFORM

(71) Applicant: TYPITO TECHNOLOGIES PVT LTD, Bangalore, Karnataka (IN)

(72) Inventors: Jatin RASTOGI, Udaipur (IN); Gaurav MISHRA, Gorakhpur (IN); Matthew JOHN, Desom Aluva (IN); Srijith SANTHOSH, Bangalore (IN)

(73) Assignee: TYPITO TECHNOLOGIES PVT LTD, Bangalore, Karnataka (IN)

(21) Appl. No.: 16/304,621

(22) PCT Filed: May 26, 2017
(86) PCT No.: PCT/IB2017/053111

§ 371 Date: Nov. 26, 2018

(30) Foreign Application Priority Data
May 26, 2016 (IN) 201641018180

(51) Int. Cl. G06T 11/60; G06F 16/958; G06F 17/22

(52) U.S. Cl. CPC G06T 11/60; G06F 16/986; G06F 3/0483; G06T 2200/24; G06F 17/2247

(57) ABSTRACT

A system and method for editing media content, by embedding graphics, text, images, icons and the like into it. An HTML overlay graphics layer is used to view the additional content in relation to the original media content. The additional content is embedded into the original media content through a rendering process once all the additions have been added by the user. The rendering may be carried out on multiple servers.

### FIELD OF TECHNOLOGY

The present invention relates to editing media content, and more particularly to a system and a method for embedding graphic overlays, text, or images using a media content editing system.

### BACKGROUND

Conventional media content editing techniques created necessary tools to create a variety of media content which gives the ability to the user to edit media by placing overlays, adding text, adding graphic overlays to create a resultant media. The resulting media presents the media content with all the original media content along with those added by the user.

One difficulty with editing media content is that of presenting media content in a meaningful way, to render the edited media content to be in synchronism with the timeline. There is a need for an interface, for editing media content, that is intuitive and easy to use and to provide edited media content that is in synchronism with the timeline.

### SUMMARY

This summary is provided to introduce a selection of concepts, in a simplified manner, which are further described in the detailed description of the invention. This summary is neither intended to identify key or essential inventive concepts of the subject matter, nor to determine the scope of the invention.

In one embodiment of the invention, a graphical user interface for editing a media content includes a media content canvas layer, a HTML based overlay graphics layer on top of the media content canvas layer, a HTML based overlay graphics renderer for displaying edited media content with overlay graphics added on top of the media content in synchronism with media content timeline, a means for storing media content overlay templates comprising one or more elements, a means for exporting the edited media content to one or more channels through the cloud servers. The network 106 may be a local area network (“LAN”), a wide area network (“WAN”), or an intranet, or a network of networks such as the internet.

In this context, the media content editing system allows a user to create or capture media, or import media content from the user's data processing system or from the web. The user may create text or graphics and overlay them at appropriate positions on the media content.

A window to display media content clip may be provided with a media content canvas layer. The user may select the media content clip either from the data processing system and may drag and drop the media content clip onto the window provided with the media content canvas layer. The user may edit the media content by adding text or graphics spatially or temporally to the media content clip. After adding the text or graphics, which are displayed as overlays, the user may export the media content so that they may be rendered. Further, the term rendering here refers to incorporating all the overlays the user wishes to add to the media content clip and creating a composite media content output.

The overlays and text may be added and the media content may be exported to a server for rendering. The media content may be rendered by at least one server and a composite media content output may be provided for download.

According to a further embodiment of the present disclosure multiple media clips could be used to create a single media clip.

To further clarify advantages and features of the present invention, a more particular description of the invention will follow by reference to specific embodiments thereof, which are illustrated in the appended figures. It is to be appreciated that these figures depict only typical embodiments of the invention and are therefore not to be considered limiting in scope. The invention will be described and explained with additional specificity and detail with the appended figures.

### BRIEF DESCRIPTION OF DRAWINGS

The invention will be described and explained with additional specificity and detail with the accompanying figures in which:

FIG. 1 is a view of the inventive system for editing media content.

FIG. 2 is a process flow of the inventive method of editing media content.

FIG. 3 is an illustrative view of the media editing system.

FIGS. 4a, 4b, 4c and 4d illustrates example of the functionality of the media editing system.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those skilled in the art having the benefit of the description herein.

### DESCRIPTION OF THE INVENTION

For the purpose of promoting an understanding of the principles of the invention, reference will now be made to the embodiment illustrated in the figures and specific language will be used to describe them. It will nevertheless be understood that no limitation of the scope of the invention is thereby intended. Such alterations and further modifications in the illustrated system, and such further applications of the principles of the invention as would normally occur to those skilled in the art are to be construed as being within the scope of the present invention.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this invention belongs. The system, methods, and examples provided herein are only illustrative and not intended to be limiting.

Embodiments of the present invention will be described below in detail with reference to the accompanying figures.

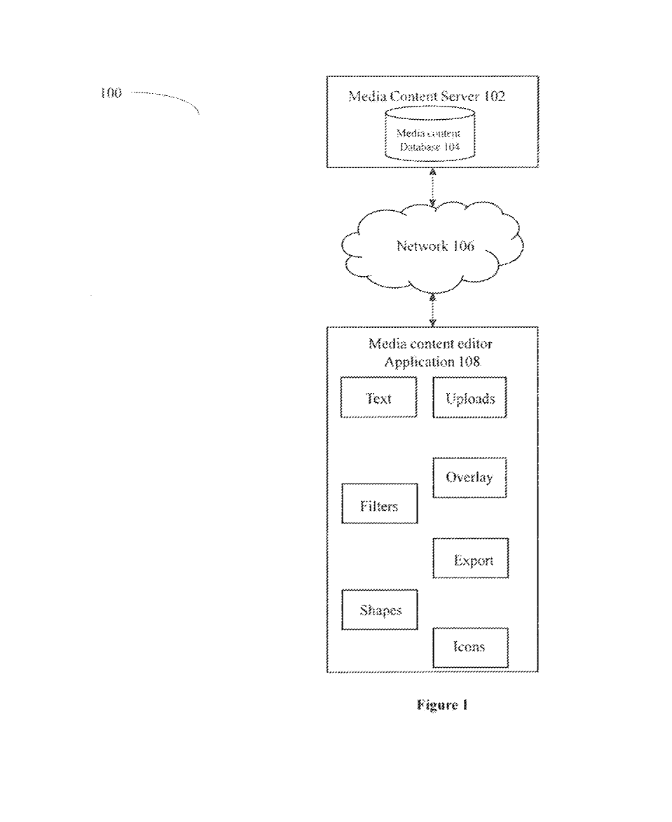

For some embodiments of the invention, FIG. 1 illustrates a view of the system for editing media content, 100, which may include a media content server 102, a media content database 104, network 106, a media content editor 108. The media content editor provides a media content canvas layer to display one or more media content clips to be edited. The media contents may be selected from a user's data processing system or from the web. An HTML based overlay graphics layer is provided on top of the media content canvas layer. Here, the phrase “on top of” means that the HTML layer is superimposed on the media content canvas layer such that when viewed by the viewer, the text or graphics intended to be added appears as a part of the media content in the media content canvas layer. The overlay graphics layer may consist of one or more overlay elements to be added to the media content. The overlay elements may consist of filters, text, graphics, shapes, icons, colours and the like. The multiple overlay elements may be added to the one or more selected media contents. The text could be in any font of user's choice.

The editing tabs may comprise colour tab, filter tab, transparency tab, and text tab. By selecting one of the tabs, a variety of media content editing options may appear in the media content canvas layer area. In one embodiment, a colour editing tab allows the user to modify brightness, hue, saturation, and contrast. In one embodiment, an effects editing tab allows the user to add media content effects to the media content layer clip. In one embodiment, a transparency editing pane allows the user to edit the visibility of the text added to the media content layer clip on the media content canvas layer. The above mentioned media content editing techniques are well known in the art.

A means for storing media content overlay templates consisting of one or more elements may be provided. The template may be a group of elements which may be reused. The group of elements may be positioned spatially with reference to the media content frame. The text may be positioned in spatial relationship of the media content which is used for similar media content to be consistent with the brand image.

Furthermore, in some embodiments, the media content editor application 108 is provided as part of a server-based (e.g., web-based) solution. The media content editor application 108 may run on a server while a user interacts with the media content editor application 108 via a separate client machine remote from the server (for example, using a web browser on the client machine) or the media content editor application may be distributed from the server to the client machine and may run on the client machine.

In one embodiment, a canvas layer may be provided for one or more videos to be edited. The HTML overlay graphics layer may be provided on top of the canvas layer. The overlays, text may be added on the HTML overlay graphics content without altering the media content.

Also, in some embodiments, the media library can provide access to media content stored in the media content editor application's database 104 or in the database of other applications executing locally or remotely. In other embodiments, the media library only provides access to media content stored in the database of other applications executing locally or remotely, as media content stored in the media content editor application's database 104 may be accessible through the browser.

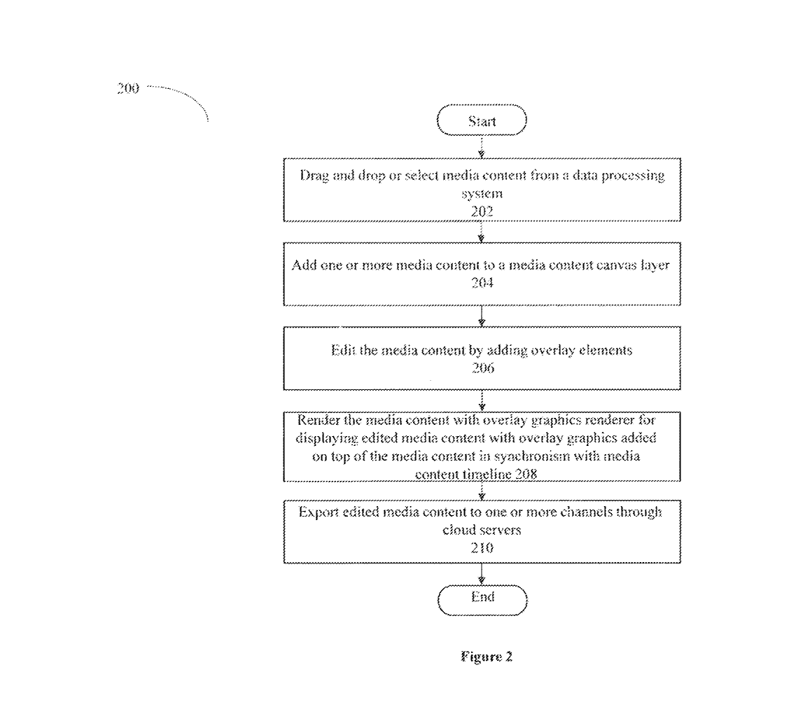

FIG. 2 illustrates a process for performing an editing operation of the media content according to some embodiments. In some embodiments, the editing of media content may be performed by a media content editor application 108.

As shown, at step 202, the process 200 starts with dragging and dropping or selecting a media content from the user's data processing system. At step 204, one or more media content may be added to the media content canvas layer. At step 206, the media content may be edited by adding the overlay elements. The overlay elements may comprise text, graphic elements, shapes, icons and the like. The multiple overlay elements may be added to the one or more selected media content. At step 208, the media content may be rendered with the overlay graphics renderer for displaying edited media content with overlay graphics added on top of the media content in synchronism with the media content timeline. At step 210, the edited media content may be exported from the media content editor application to one or more channels through the cloud servers.

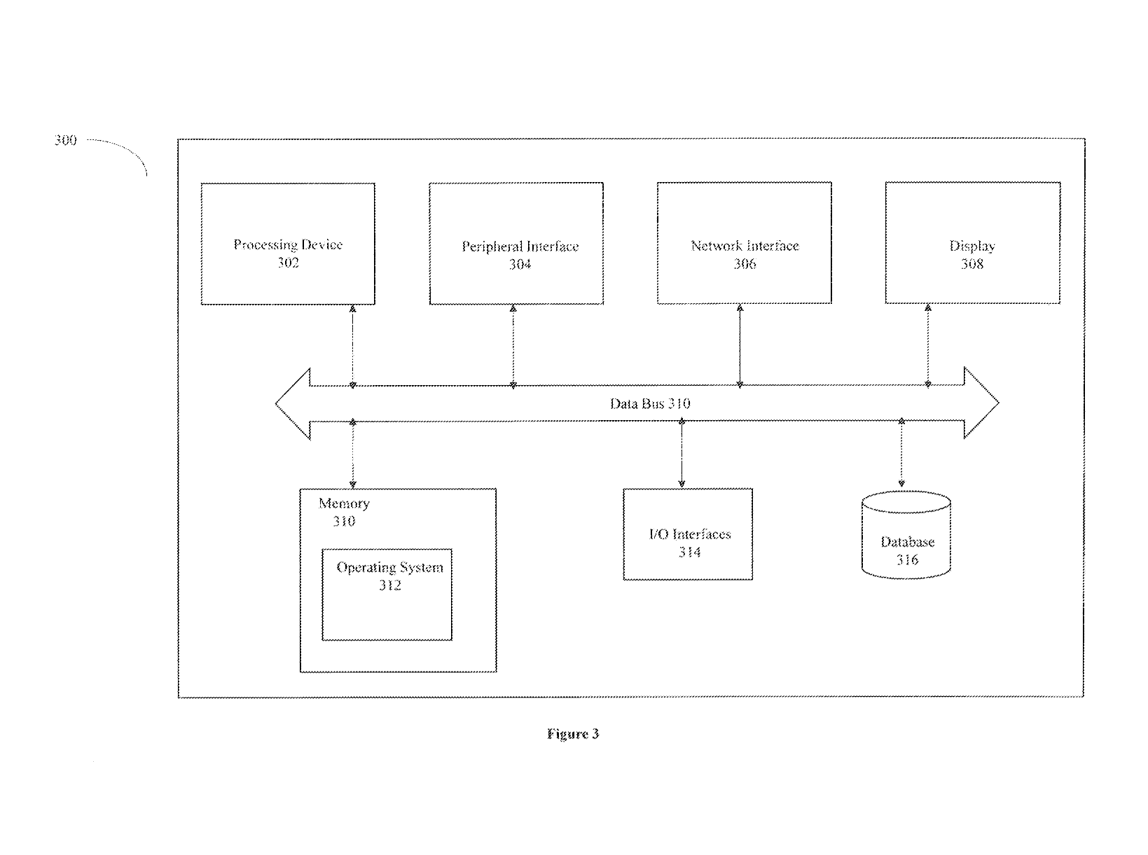

FIG. 3 is an illustrative view 300 of the media editing system. The video editing system may be embodied in any one of a wide variety of wired and/or wireless computing devices, such as a desktop computer, portable computer, dedicated server computer, multiprocessor computing device, smartphone, tablet computing device, and so forth. As shown in FIG. 3, the media editing system comprises memory 310, a processing device 302, a number of input/output interfaces 314, a network interface 306, a display 308, a peripheral interface 304, wherein each of these devices are connected across a local data bus 310.

The processing device 302 may include any custom made or commercially available processor, a central processing unit (CPU) or an auxiliary processor among several processors associated with the media editing system, a semiconductor based microprocessor (in the form of a microchip), a macro processor, one or more application specific integrated circuits (ASICs), a plurality of suitably configured digital logic gates, and other well-known electrical configurations comprising discrete elements both individually and in various combinations to coordinate the overall operation of the computing system.

The memory 310 can include any one of a combination of volatile memory elements (e.g., random-access memory (RAM, such as DRAM, and SRAM, etc.)) and nonvolatile memory elements (e.g., ROM, hard drive, tape, CDROM, etc.). The memory 310 typically comprises a native operating system 312, one or more native applications, emulation systems, or emulated applications for any of a variety of operating systems and/or emulated hardware platforms, emulated operating systems, etc. One of ordinary skill in the art will appreciate that the memory 310 can, and typically will, comprise other components which have been omitted for purposes of brevity.

Input/output interfaces 314 provide any number of interfaces for the input and output of data. For example, where the media editing system comprises a personal computer, these components may interface with one or more user input devices via the I/O interfaces 314, where the user input devices may comprise a keyboard or a mouse. The display 308 may comprise a computer monitor, a plasma screen for a PC, a liquid crystal display (LCD), a touchscreen display, or other display device

In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical).

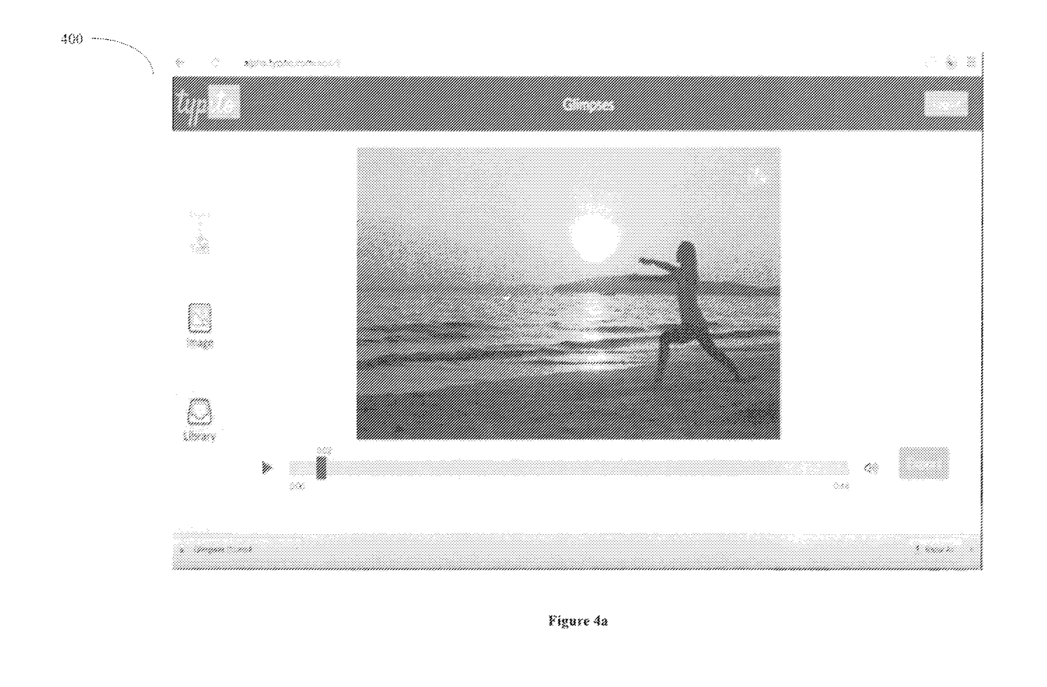

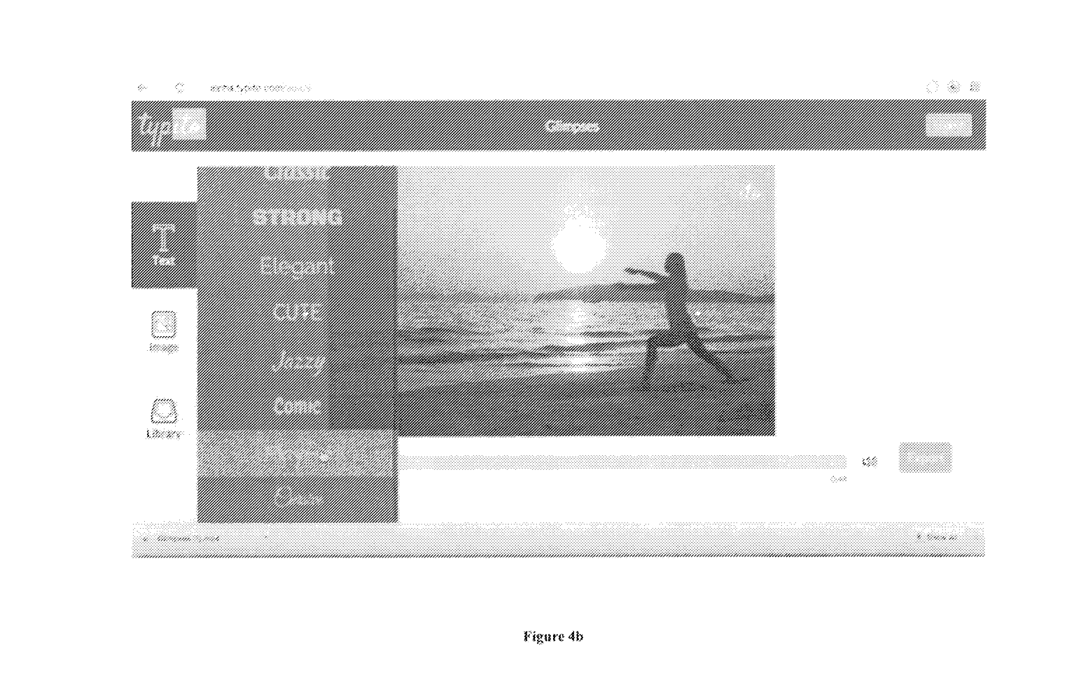

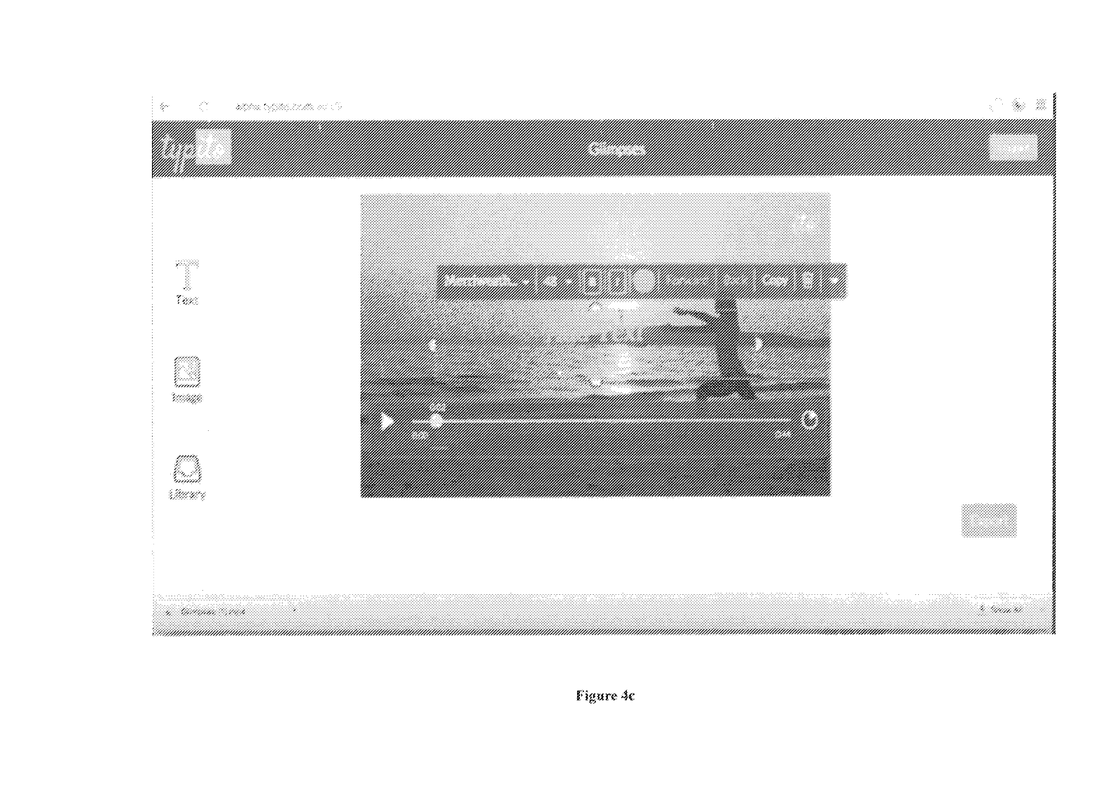

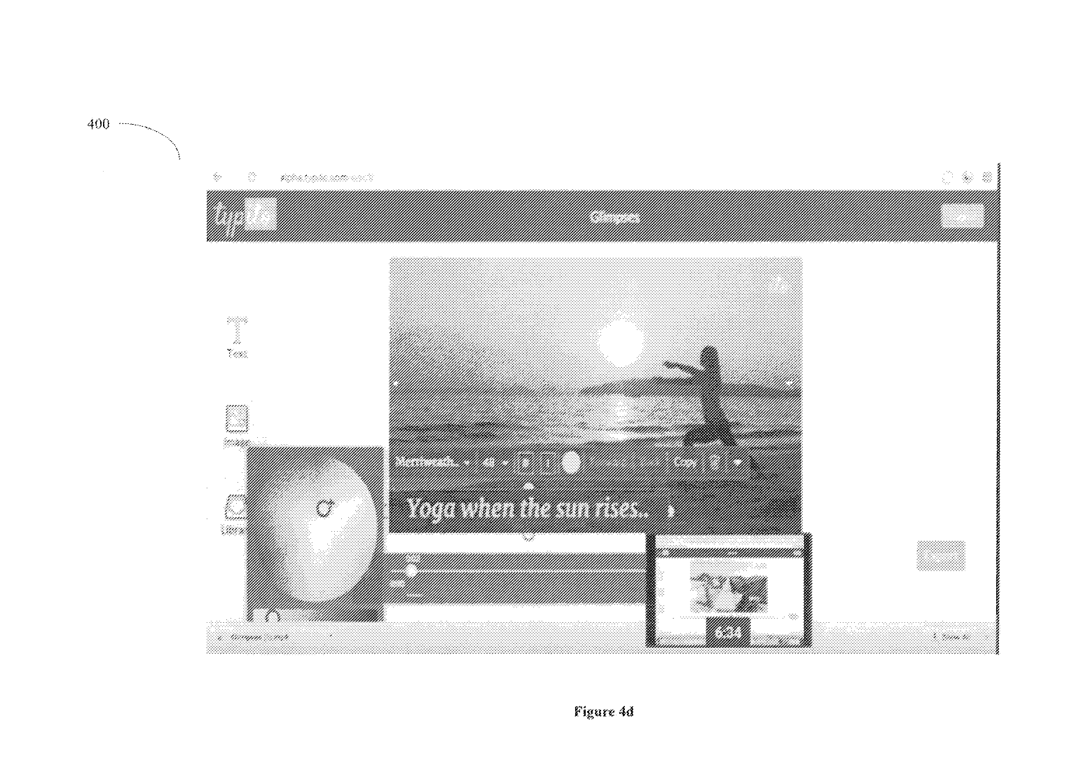

FIGS. 4a, 4b, 4c and 4d depicts the examples of the functionality of the media editing system. FIG. 4a shows media contents which may be selected from a user's data processing system or from the web. FIG. 4b shows a user interface of the media editing system which includes effects or text bar to insert graphics, text or the like. FIG. 4c may include a timeline component which may be used by the user to seek to a particular time of the media content. FIG. 4d illustrates providing an HTML based overlay graphics layer on top of the media content canvas layer. such that when viewed by the viewer, the text or graphics intended to be added appears as a part of the media content in the media content canvas layer. The overlay graphics layer may consist of one or more overlay elements to be added to the media content. The overlay elements may consist of filters, text, graphics, shapes, icons, colours and the like.

While specific language has been used to describe the invention, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

1. A method for editing media comprising:
selecting media content from one or more data processing system;
adding one or more media content to a media content canvas layer;
editing the media content by adding overlay elements;
rendering the media content with overlay graphics renderer for displaying edited media content with overlay graphics added on top of the media content in synchronism with media content timeline; and
exporting edited media content to one or more channels through cloud servers.

2. The method of claim 1, wherein selecting the media content from one or more user's data processing system or from the web.

3. The method of claim 1, wherein an HTML based overlay graphics layer is provided on top of the media content canvas layer.

4. The method of claim 3, wherein superimposing a HTML layer on the media content canvas layer such that when viewed by the viewer, the text or graphics intended to be added appears as a part of the media content in the media content canvas layer.

5. The method of claim 3, wherein the overlay graphics layer consists of one or more overlay elements to be added to the media content.

6. A system for editing media comprising:
select media content from one or more data processing system;
add one or more media content to a media content canvas layer;
edit the media content by adding overlay elements;
render the media content with overlay graphics renderer for displaying edited media content with overlay graphics added on top of the media content in synchronism with media content timeline; and
export edited media content to one or more channels through cloud servers.

7. The system of claim 6, wherein selecting the media content from one or more user's data processing system or from the web.

8. The system of claim 6, wherein an HTML based overlay graphics layer is provided on top of the media content canvas layer.

9. The system of claim 8, wherein superimposing a HTML layer on the media content canvas layer such that when viewed by the viewer, the text or graphics intended to be added appears as a part of the media content in the media content canvas layer.

10. The system of claim 8, wherein the overlay graphics layer consists of one or more overlay elements to be added to the media content.
